(19) United States
(12) Patent Application Publication
(10) Pub. No.: US 2004/0235417 A1
(43) Pub. Date: Nov. 25, 2004

(54) Repeater oscillation prevention

(76) Inventor: Richard F. Dean, Lyons, CO (US)

Correspondence Address: Qualcomm Incorporated, Patents Department, 5775 Morehouse Drive, San Diego, CA, 92121-1714, US

(21) Appl. No.: 10/786,709

(22) Filed: Feb. 24, 2004

Related U.S. Application Data
(60) Provisional application No. 60/449,807, filed on Feb. 24, 2003.

(51) Int. Cl. H04B 1/60; H04B 17/02

(52) U.S. Cl. 455/10; 455/9

(57) ABSTRACT

A method and apparatus for detecting oscillation in a repeater system is disclosed. More particularly, in one embodiment, a wireless communication device is embedded in a repeater system and is configured to detect if the repeater system is in oscillation. A processor coupled to the WCD is configured to reduce the gain of the repeater system if the repeater system is in oscillation.

### CROSS-REFERENCE TO RELATED APPLICATIONS

The present Application for Patent claims priority to Provisional Application No. 60/449,807 entitled “Repeater Oscillation Prevention” filed Feb. 24, 2003, and assigned to the assignee hereof and hereby expressly incorporated by reference herein.

### BACKGROUND

I. Field of Invention

The invention generally relates to wireless communication systems, and more particularly, to a repeater for use in wireless communication systems having an embedded wireless communication device capable of interacting with base stations communicating with and through the repeater to prevent repeater oscillation.

II. Description of the Related Art

In wireless communication systems, mobile stations or user terminals receive signals from fixed position base stations (also referred to as cell cites or cells) that support communication links or service within particular geographic regions adjacent to or surrounding the base stations. In order to aid in providing coverage, each cell is often sub-divided into multiple sectors, each corresponding to a smaller service area or geographic region. A network of base stations provides wireless communication service to an expansive coverage area. Due to various geographic and economic constraints, the network of base stations does not provide adequate communication services in some areas within the coverage area. These “gaps” or “holes” in the coverage area may be filled with the use of repeaters.

Generally, a repeater is a high gain bidirectional amplifier and comprises an antenna for receiving signals and an antenna for transmitting signals received by the repeater. Thus, repeaters receive, amplify and re-transmit signals to and from the communication device and a base station. The repeater may provide communication service to the coverage hole, which was previously not serviced by the base station. Repeaters may also augment the coverage area of a sector by shifting the location of the coverage area or altering the shape of the coverage area. Accordingly, repeaters can play an integral role in providing wireless communication.

However, repeaters can oscillate if the isolation between the antennas is not sufficient.

### SUMMARY

Embodiments disclosed herein address the above stated needs by providing a wireless communication device to detect whether the repeater is in oscillation. In one aspect, a method for detecting oscillation in a repeater system comprises embedding a wireless communication device circuit in the repeater; and using the wireless communication device circuit to determine if the repeater system is in oscillation. Here, using the wireless communication device circuit may comprise establishing a call from the wireless communication device circuit to a base station; and determining oscillation if the call cannot be established. Alternatively, using the wireless communication device circuit may comprise using the wireless communication device circuit to measure signal quality from the base station; and determining oscillation if the signal quality meets a certain criteria. Oscillation is determined if the signal quality degrades below a certain level and/or if the signal quality degrades from a level that existed before the repeater was used. In still an alternative embodiment, using the wireless communication device circuit comprises using the wireless communication device circuit to estimate at least one open loop power control parameter; establishing a communication link from the wireless communication device circuit to a base station using the estimated open loop power control parameter; receiving at least one closed loop power control command from the base station; and determining oscillation if the closed loop power control command is greater than a certain amount.

In another aspect, an apparatus for detecting oscillation in a repeater system comprises a wireless communication device circuit embedded in the repeater; and means for using the wireless communication device circuit to determine if the repeater system is in oscillation. Here, the means for using the wireless communication device circuit may comprise means for establishing a call from the wireless communication device circuit to a base station; and means for determining oscillation if the call cannot be established. The means for using the wireless communication device circuit may comprise means for using the wireless communication device circuit to measure signal quality from the base station; and means for determining oscillation if the signal quality meets a certain criteria. The means for using the wireless communication device circuit may also comprise means for using the wireless communication device circuit to estimate at least one open loop power control parameter; means for establishing a communication link from the wireless communication device circuit to a base station using the estimated open loop power control parameter; means for receiving at least one closed loop power control command from the base station; and means for determining oscillation if the closed loop power control command is greater than a certain amount.

In a further aspect, an apparatus of for detecting oscillation in a repeater system comprises a wireless communication device (WCD) configured to detect if the repeater system is in oscillation; and a processor coupled to the WCD, configured to reduce the gain of the repeater system if the repeater system is in oscillation.

### BRIEF DESCRIPTION OF THE DRAWINGS

Various embodiments will be described in detail with reference to the following drawings in which like reference numerals refer to like elements, wherein:

FIG. 1 is an example of a wireless communication network;

FIG. 2 is an example of a basic repeater;

FIG. 3 shows an example of system oscillation in a repeater;

FIG. 4 shows an example of a repeater system having an embedded wireless communication device;

FIG. 5 shows an example process for detecting system oscillation; and

FIGS. 6 to 8 show example processes for determining system oscillation using an embedded wireless communication device.

### DETAILED DESCRIPTION

Embodiments as disclosed allow detection of repeater oscillation by embedding a wireless communication device within the repeater. Using the wireless communication device, a determination of whether the repeater is in oscillation may be made by the ability to complete a call, the signal quality, and/or closed loop power control, as available. If the system is determined to be in oscillation, the repeater gain can be reduced such that the system is no longer in oscillation.

In the following description, specific details are given to provide a thorough understanding of the embodiments. However, it will be understood by one of ordinary skill in the art that the embodiments may be practiced without these specific detail. For example, circuits may be shown in block diagrams in order not to obscure the embodiments in unnecessary detail. In other instances, well-known circuits, structures and techniques may be shown in detail in order not to obscure the embodiments.

It is also noted that the embodiments may be described as a process which is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, as disclosed herein, a storage medium may represent one or more devices for storing data, including read only memory (ROM), random access memory (RAM), magnetic disk storage mediums, optical storage mediums, flash memory devices and/or other machine readable mediums for storing information. The term “machine readable medium” includes, but is not limited to portable or fixed storage devices, optical storage devices, wireless channels and various other mediums capable of storing, containing or carrying instruction(s) and/or data.

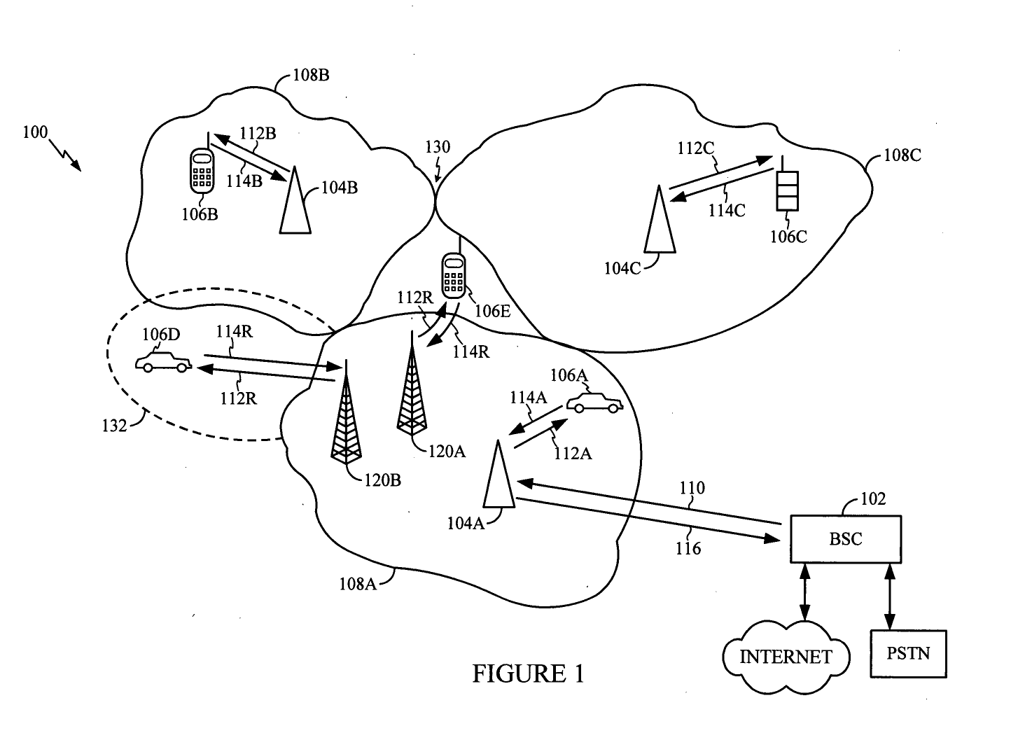

Before describing the embodiments in detail, it is helpful to describe an example environment in which they may be usefully implemented. While the embodiments may be implemented in various environments and/or systems, the embodiments are particularly useful in mobile communication system environments. FIG. 1 illustrates such an environment.

I. Exemplary Operational Environment

FIG. 1 illustrates an example of a wireless communication network (hereinafter “network”) 100 using one or more control stations 102, sometimes referred to as base station controllers (BSC), and a plurality of base stations 104A-104C, sometimes referred to as base station transceiver system (BTS). Base stations 104A-104C communicate with remote stations or wireless communication devices 106A-106C that are within service areas 108A-108C of base stations 104A-104C, respectively. In the example, base station 104A communicates with remote station 106A within service area 108A, base station 104B with remote station 106B within service area 108B, and base station 104C with remote station 106C within service area 108C.

Base stations transmit information in the form of wireless signals to user terminals across forward links or forward link communication channels, and remote stations transmit information over reverse links or reverse link communication channels. Although FIG. 1 illustrates three base stations 104A-104C, other numbers of these elements may be employed to achieve a desired communications capacity and geographic scope, as would be known. Also, while fixed base stations are described, it is to be appreciated that in some applications, portable base stations and/or stations positioned on movable platforms such as, but not limited to, trains, barges or trucks, may be used as desired.

Control station 102 may be connected to other control stations, central system control stations (not shown) for network 100 or other communication systems such as a public switched telephone network (PSTN) or the Internet. Thus, a system user at remote station 106 is provided with access to other communication portals using network 100.

Base stations 104A-104C may form part of terrestrial based communication systems and networks that include a plurality of PCS/cellular communication cell-sites. They can be associated with CDMA or TDMA (or hybrid CDMA/TDMA) digital communication systems, transferring CDMA or TDMA type signals to or from remote stations. Signals can be formatted in accordance with IMT-2000/UMT standards, using WCDMA, CDMA2000 or TD-SCDMA type signals. On the other hand, base stations 104 can be associated with an analog based communication system (such as AMPS), and transfer analog based communication signals.

Remote stations 106A-106C each have or comprise apparatus or a wireless communication device (WCD) such as, but not limited to, a cellular telephone, a wireless handset, a data transceiver, or a paging or position determination receiver. Furthermore, such remote stations can be hand-held, portable as in vehicle mounted (including cars, trucks, boats, trains, and planes) or fixed, as desired. In FIG. 1, remote station 106A is a portable vehicle mounted telephone or WCD, remote station 106B is a hand-held apparatus, and remote station 106C is a fixed device.

In addition, the teachings of the invention are applicable to wireless devices such as one or more data modules or modems which may be used to transfer data and/or voice traffic, and may communicate with other devices using cables or other known wireless links or connections, for example, to transfer information, commands, or audio signals. Commands may be used to cause modems or modules to work in a predetermined coordinated or associated manner to transfer information over multiple communication channels. Wireless communication device remote stations are also sometimes referred to as user terminals, mobile stations, mobile units, subscriber units, mobile radios or radiotelephones, wireless units, or simply as ‘users,’ ‘phones,’ ‘terminals,’ or ‘mobiles’ in some communication systems, depending on preference.

In the present example environment, remote stations 106A-106C and base stations 104A-104C engage in wireless communications with other elements in network 100 using CDMA communication techniques. Therefore, signals transmitted across the forward (to the remote stations) and reverse links (from the remote stations) convey signals that are encoded, spread, and channelized according to CDMA transmission standards. A forward CDMA link includes a pilot channel or signal, a synchronization (sync)-channel, several paging channels, and a larger number of traffic channels. The reverse link includes an access channel and a number of traffic channels. The pilot signal is used to alert mobile stations of the presence of a CDMA-compliant base station. The signals use data frames having a predetermined duration, such as 20 milliseconds. However, this is for convenience in description, and the present invention may be employed in systems that employ other communications techniques, such as time division multiple access (TDMA), and frequency division multiple access (FDMA), or other waveforms or techniques as listed above, as long as the communication system or network sends power control commands to the remote station.

In any case, the wireless signals need to be transmitted at power levels sufficient to overcome noise and interference so that the transfer of information occurs within specified error rates. However, these signals need to be transmitted at power levels that are not excessive so that they do not interfere with communications involving other remote stations. Faced with this challenge, base stations and remote stations in some communication techniques can employ dynamic forward link power control techniques to establish appropriate forward link transmit power levels.

Conventional forward link power control techniques involve closed loop approaches where user terminals provide base stations with feedback that specifies particular forward link transmit power adjustments, referred to as up/down commands because they direct either a power increase or a power decrease. For example, one such approach involves a user terminal determining signal-to-noise ratios (SNRs) or bit error rates (BER) of received forward link traffic signals, and requesting the base station to either increase or decrease the transmit power of traffic signals sent to the remote station based on the results. In addition to transmitting up/down commands, other types of information may be transmitted to base stations periodically including various power and noise measurements to support operations, such as “handoffs” between base stations.

Typically, base stations 104A-104C adjust the power of the signals that they transmit over the forward links of network 100. This power (referred to herein as forward link transmit power) may be varied according to requests by, information from, or parameters for remote stations 106A-106C, and according to time. This time varying feature may be employed on a frame-by-frame basis. Such power adjustments are performed to maintain forward link BER or SNR within specific requirements, reduce interference, and conserve transmission power.

Remote stations 106A-106C also adjust the power of the signals that they transmit over the reverse links of network 100, under the control of control station 102 or base stations 104A-104C. This power (referred to herein as reverse link transmit power) may be varied according to requests by or commands from a BTS, received signal strength or characteristics, or parameters for remote station operation, and according to time. This time varying feature may be employed on a frame-by-frame basis. Such power adjustments are performed to maintain reverse link bit error rates (BER) within specific requirements, reduce interference, and conserve transmission power.

Examples of techniques for exercising power control in such communication systems are found in U.S. Pat. No. 5,383,219, entitled “Fast Forward Link Power Control In A Code Division Multiple Access System,” U.S. Pat. No. 5,396,516, entitled “Method And System For The Dynamic Modification Of Control Parameters In A Transmitter Power Control System,” and U.S. Pat. No. 5,056,109, entitled “Method and Apparatus For Controlling Transmission Power In A CDMA Cellular Mobile Telephone System.”

II. Service Areas

Each base station has a respective service area 108 (108A-108C) which can be generally described as the geographical extent of a locus of points for which a remote station 106 can communicate effectively with the base station. As an example, when a remote station 106 is within a service area 108, messages can be transmitted from control center 102 to a base station 104 (104A-104C) using a forward link 110 (110A-110C), and from base station 104 to a remote station 106 using a forward link 112 (112A-112C). Messages are transmitted from a remote station 106 to a base station 104 over a return link 114 (114A-114C). These messages are transmitted to the control center 102 using a return link 116 (116A-116C).

Some or all of the communications between a base station 104 and control station 102 can be carried over other wireless, such as microwave, radio, or satellite type links, or non-wireless transfer mechanisms such as, but not limited to dedicated wireline services, optical or electronic cables and so forth. Also, messages transmitted using forward links 110 and 112 may be modulated in different frequency bands or modulation techniques than the messages transmitted over reverse links 114 and 116. The use of separate forward and reverse links allows full duplex communications between the control center 102 and the remote station 106. TD-SCDMA systems use time division duplexing to accomplish the forward and reverse links, so a repeater may be implemented using either time division duplexing or frequency division duplexing.

The service area of a base station is illustrated as generally circular or elliptical in FIG. 1 for convenience. In actual applications, local topography, obstructions (buildings, hills, and so forth), signal strength, and interference from other sources dictate the shape of the region serviced by a given base station. Typically multiple coverage areas 108 (108A-108C) overlap, at least slightly, to provide continuous coverage or communications over a large area or region. That is, in order to provide an effective mobile telephone or data service, many base stations would be used with overlapping service areas, where the edges have decreased power.

One aspect of the communication network coverage illustrated in FIG. 1, is the presence of an uncovered region 130, which can often be referred to as a hole, or an uncovered region 132 which is simply outside of network 100 normal coverage areas. In the case of a “hole” in coverage, there are areas surrounding or at least adjacent to the covered areas which can be serviced by base stations, here base stations 104A-104C. However, as discussed above a variety of reasons exist for which coverage might not be available in regions 130 or 132.

For example, the most cost effective placement of base stations 104A-104C might place them in locations that simply do not allow their signals to reliably reach or cover regions 130 or 132. Alternatively, topological features such as mountains or hills, man made structures, such as tall buildings or urban canyons often created in central urban corridors, or vegetation, such as tall trees, forests, or the like, could each partially or completely block signals. Some of these effects can be temporary, or change over time, to make system installation, planning, and use even more complex.

In many cases, it may also be more amenable to using several repeaters to cover unusually shaped regions or circumvent the problems of blockage. In this situation, one or more repeaters 120 (120A, 120B) accept transmissions from both a remote station 106 (106D and 106E) and a base station 104

A), and act as an intermediary between the two, essentially operating as a “bent pipe” communication path. Using a repeater 120, the effective range of a base station 104 is extended to cover service areas 130 and 132.

While the use of repeaters 120 is a more cost effective way to increase range or coverage for base stations, the antennas of repeater 120 need to have sufficient isolation to prevent oscillation.

III. Repeater Overview

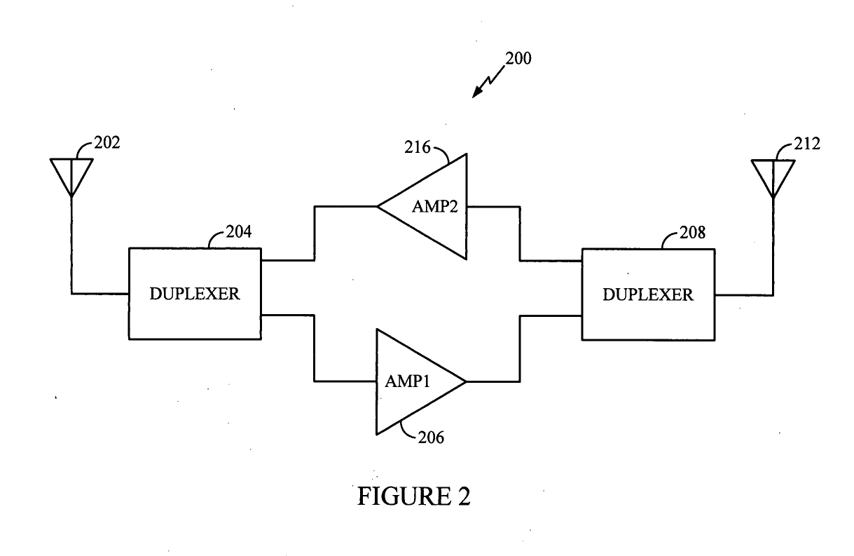

FIG. 2 shows a simplified block diagram of a repeater 200. A more typical commercial repeater may have additional components including additional filtering and control elements to control noise, out of band emissions, and to regulate the gain. Repeater 200 comprises a donor antenna 202 for receiving signals, a duplexer 204, an amplifier 206 for amplifying signals received at donor antenna 202, a second duplexer 208, and a server or coverage antenna 212 for transmitting (or repeating) signals received by repeater 200. A second amplifier 216 is also included which amplifies signals received at server antenna 206, and provides the amplified signals to donor antenna 202.

The receive or receiver duplexer 204 is coupled to an antenna referred to as a donor antenna 202, since it receives signals “donated” from another source, such as a base station, also referred to as a donor cell. The donor is more typically not a cell or cell site but a sector within a cell being handled by the donor base station. The antenna coupled to the duplexer 208 on the transmission or output side of the repeater processing is referred to as the output or coverage antenna 212. Two duplexers 204, 208 are used to split or separate the forward link and reverse link signals (frequencies) to provide necessary isolation between the two so that they do not enter the other processing chains of repeater 200. That is, to prevent transmissions from entering receivers, and so forth, and degrading performance.

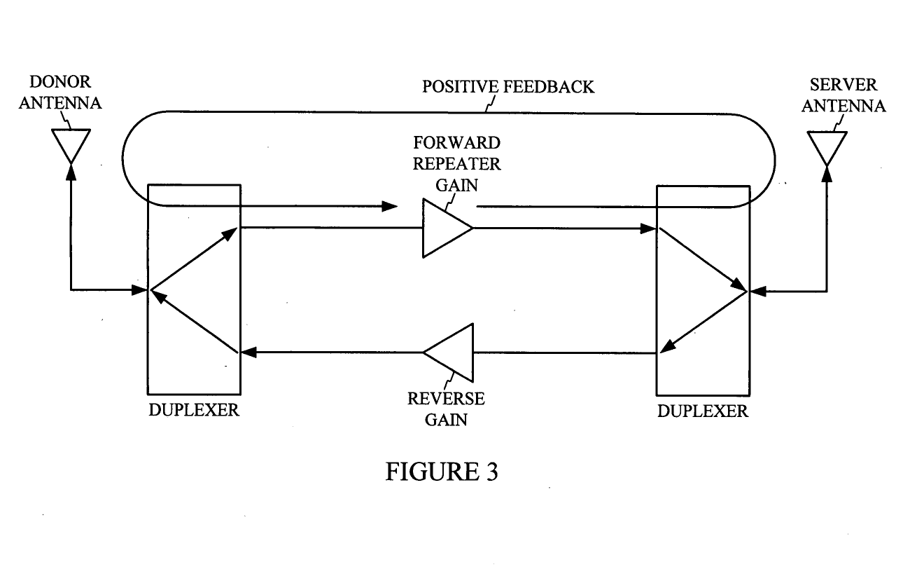

However, repeaters can still oscillate without sufficient isolation between donor and server antennas. More particularly, FIG. 3 shows that the transmissions from server antenna are being fed back to donor antenna due to insufficient antenna isolation, thereby causing system oscillation. To avoid this positive feedback, the antenna isolation should be a certain dB higher than the repeater gain.

Accordingly, even if the donor and server antennas are installed initially with sufficient antenna isolation, changes in the repeater gain may cause the system to oscillate. For example, the repeater gain may change due to power adjustment information as will be discussed below in case of power controlled repeaters. The repeater gain may also change due to environmental conditions around the repeater, such as temperature changes, and/or between the repeater and a base station, such as changes in topological features. Therefore, embodiments disclosed below detect whether a repeater is in oscillation during the lifetime of the repeater. The embodiments are also applicable to determine whether a repeater is in oscillation when installing the repeater and the antennas.

IV. Oscillation Prevention

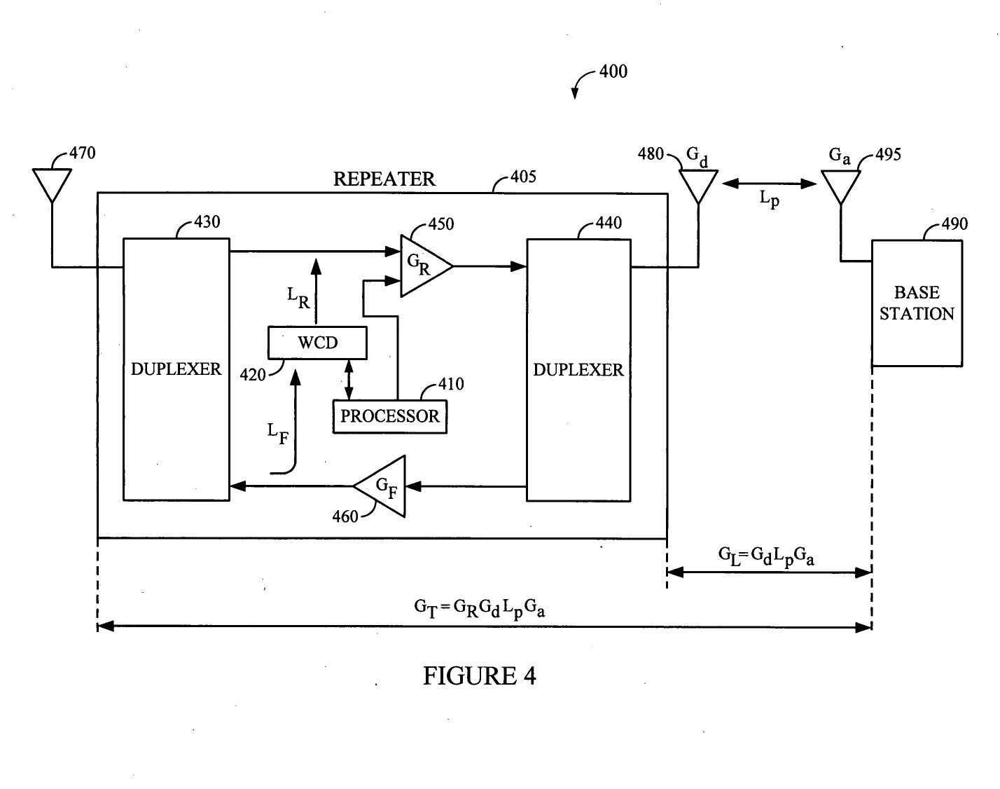

Generally, system oscillation is detected by embedding a wireless communication device (WCD) in a repeater. FIG. 4 shows a repeater system 400 that allow determination of whether the system is in oscillation. That is, a functional and parameter based replica of the operations performed within system 400 is shown. Some parameters used in the model are shown in Table

TABLE I

| Parameter | Definition |
|---|---|
| G_{F} | Forward link gain of repeater |
| G_{R} | Reverse link gain of repeater |
| L_{R} | Loss between the WCD and reverse link gain |
| L_{F} | Loss between the forward link gain and the WCD |
| G_{d} | Gain of the donor antenna on repeater |
| Lₚ | Path loss between repeater and WCD |
| Gₐ | Antenna gain of base station |
| G_{T} | Total reverse link gain of repeater |

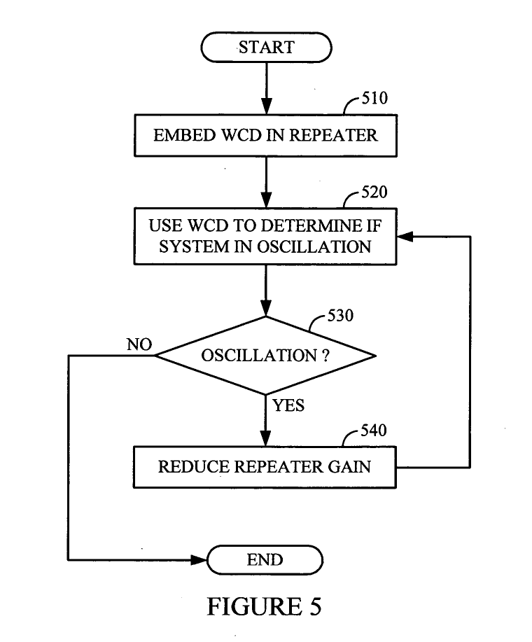

System 400 shows a repeater 405 communicating with a base station 490. Repeater 405 may comprise processor 410, WCD 420, duplexers 430 and 440, amplifiers 450 and 460, and donor and server antennas 470 and 480. As in repeater 200, a more typical commercial repeater may have additional components. Processor 410 may be a device or circuitry such as a central processor, microprocessor or a digital signal processor to control WCD 420 and/or amplifier 450. WCD 420 may be implemented using circuitry that is analogous to a remote station. Also, processor 410 and WCD 420 may be implemented on one or more apparatus or circuit card or board assembly. The operation will be described with reference to a process 500 as shown in FIG. 5.

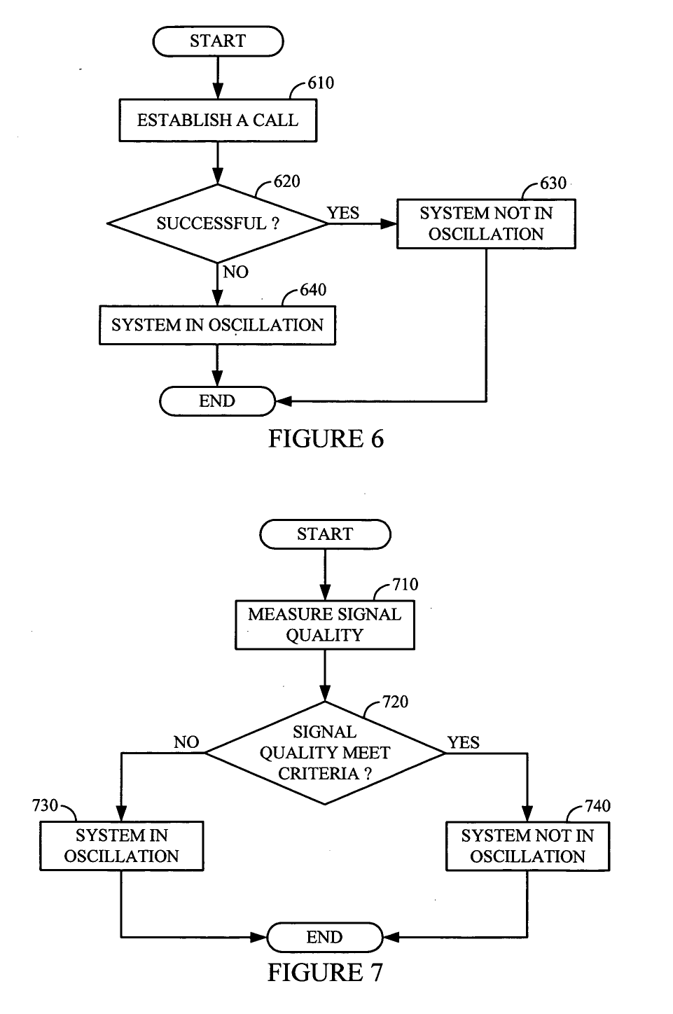

To detect system oscillation, a WCD is embedded (510) in a repeater and the WCD is used to determine (520) if the system is in oscillation. If the system is in oscillation, the repeater gain is reduced (530 and 540). Here, processor 410 may control amplifier 450 to adjust the repeater gain. Also, the WCD may be used in various ways to determine and/or detect if the system is in oscillation. FIG. 6 shows a process 600 to detect system oscillation.

Using WCD 420, a call is attempted to be established (610) between WCD 420 and base station 490. If successful, the system is not determined (620 and 630) to be in oscillation. That is, if the call can be established, the system is assumed not in oscillation. If a call cannot be established, the system is determined (640) to be in oscillation.

Alternatively, system oscillation can also be detected by process 700 as shown in FIG. 7. In this embodiment, the signal quality from the base station is measured (710) using WCD 420. If the signal quality meets a certain criteria, the system is assumed (720 and 740) not in oscillation. If the signal quality does not meet the certain criteria, the system is determined (720 and 730) to be in oscillation. More particularly, the system is determined to be in oscillation if the signal quality degrades below a certain level. Also, if the signal quality degrades by a certain amount from a level that existed before repeater 405 was used, the system is determined to be in oscillation. Here, the signal quality may be measured by obtaining the signal to noise value. For example, in CDMA communication systems, the ratio of energy of a chip of the pilot signal to the total interference Ec/lo may be measured using known techniques. In addition, the signal quality may be measured by establishing a call or by establishing a reverse communication link. In the latter case, WCD 420 may be implemented by a receiver circuitry in which signals need not be transmitted.

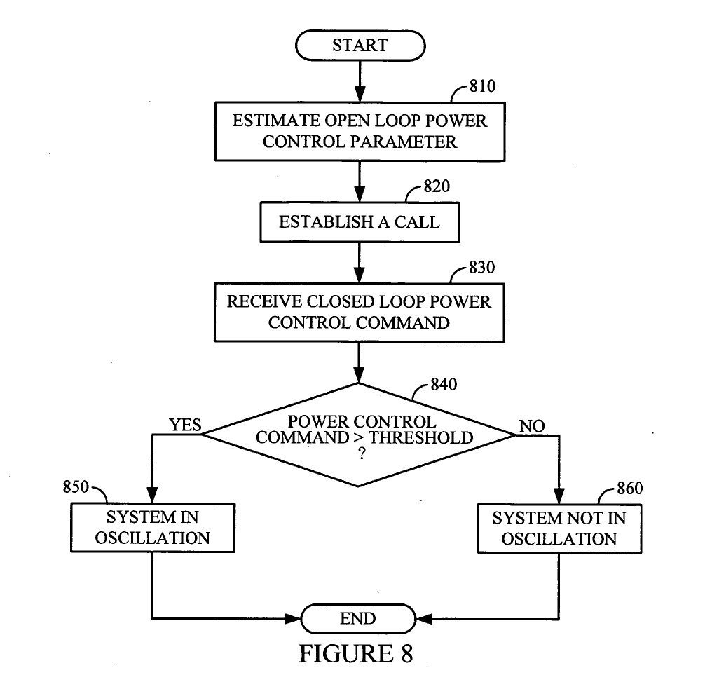

For power controlled repeaters, FIG. 8 shows another process 800 to detect system oscillation. In a power controlled repeater, a remote station circuitry such as a subscriber unit is embedded inside a repeater. This is described in co-pending U.S. patent application Ser. No. 10/300,969 entitled “Reverse Link Power Controlled Repeater” which is assigned to the assignee of the embodiments and is incorporated herein by reference. Generally, the remote station is configured in such a way so as to control the reverse link gain of the repeater. Although the remote station may be various wireless communication devices, for purposes of explanation, the embodiment will be described using a mobile phone. The embedded phone controls the reverse link gain based on the power control commands that are received from the network. The power control commands from the network are designed to optimize the receive signal power from the mobile so that it arrives at the BS with sufficient power for the signal to be demodulated. This same control can be used to set the reverse link gain of the repeater.

With the embedded remote station or WCD, one can also establish periodic calls or communication sessions between the repeater and a base station, and utilize reverse link power-control for the WCD to calibrate or re-calibrate the gain of the repeater. This improves repeater performance in general and also allows the repeater to dial-in automatically during repeater installation to establish and then maintain a desired operating point throughout a use period, which could be useful life, of the repeater. This effectively compensates for variations in repeater-to-BTS path loss, environmental conditions, amplifier aging, and changes in user load that deleteriously impact the reverse link for the repeater. The power controlled repeater also stabilizes the reverse link operating point, essentially keeping remote stations in the repeater coverage area from “hitting” the BTS with too much or too little power.

The call from the embedded phone to the network may be initiated by an entity on the network side. The call could also be initiated automatically by the repeater. The length of the call is short, for example approximately 2 to 5 seconds on average. A call is placed to the repeater (or by the repeater) at regular intervals during the day in order to continuously manage the repeater to BS link.

Referring back to FIG. 4, total reverse link gain GT is modeled as comprising four components. The BS antenna gain, the path loss between the BS and the repeater, the donor antenna gain, and the reverse gain of the repeater. After the antennas are mounted and pointed, the antenna gains can be assumed stable. Assuming a fixed location and a line of sight path, the path loss between the repeater and the BS should also remain constant. If the path between the repeater and the BS is not line of sight, then changes in the clutter environment will likely cause this loss to vary. These variations will directly affect the total link gain, G_{T}. Finally, variations in the repeater gain due to changes in the amplifier chain will result in variations to G_{T}.

Power control may be used to maintain a consistent total reverse link gain, G_{T} between the BS and the repeater. To maintain repeater link balance, any change to the forward communication link gain (GF) requires adjustment to the reverse link gain. The forward link gain may change due to various reasons, one of which is some change in the path loss, L_{P}. Another reason is some change in the repeater forward gain electronics, for example, due to gain fluctuations as a function of temperature.

To operate, the embedded phone is brought into the traffic state. Namely, closed loop power control commands are sent to the phone. The embedded phone is configured in such a way that the reverse link transmit signals are carried through the entire reverse link gain states of the repeater. In this way, the received signal at base station 490 will reflect the gain found in the repeater. If the gain of the repeater has drifted, or if the path loss between the repeater and the base station has changed, these changes will be reflected in the closed loop power control commands that are sent to the embedded mobile station. In normal CDMA phone operation these power control commands would cause the mobile phone to adjust its transmit power. In the case of the power controlled repeater, the power commands to the embedded phone will cause the gain of the entire repeater to change. In this way, the feedback provided by the network is used to compensate for any changes in the gain chain of the repeater or any changes in the path loss between the repeater and the base station.

Accordingly, the embedded WCD 420 may be configured in such a way so as to control the reverse link gain of repeater 405 based on the power control commands that are received from the network. Here, the power control commands would be closed loop power control commands. Therefore, referring back to FIG. 8, system oscillation may be detected (810) by estimating at least one open loop power control parameter. A communication link such as a call is then established (820) from WCD 420 to base station 490 using the estimated open loop power control parameter. WCD 420 then receives (830) at least one closed loop power control command from base station 490. The system is determined (840 and 850) to be in oscillation if the closed loop power control command is greater than a certain amount or threshold. Otherwise, the system is determined (840 and 860) not in oscillation. Here, the estimated power control parameter may be the transmit power level that is required to complete a call and the power control command may be the power adjustment information.

### V. CONCLUSION

As described, system oscillation may be detected in various ways by embedding a wireless communication device in a repeater. Depending upon the configuration and/or the needs of the system one or more than of one of processes 600 to 800 may be implemented. Once system oscillation is detected, processor 410 may be configured to reduce the repeater gain.

Furthermore, embodiments may be implemented by hardware, software, firmware, middleware, microcode, or any combination thereof. When implemented in software, firmware, middleware or microcode, the program code or code segments to perform the necessary tasks may be stored in a machine readable medium such as a storage medium or mediums (not shown). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

It should be apparent to those skilled in the art that the elements of system 400 may be rearranged without affecting the operation of the repeater. Also, it should be noted that the foregoing embodiments are merely examples and are not to be construed as limiting the invention. The description of the embodiments is intended to be illustrative, and not to limit the scope of the claims. As such, the present teachings can be readily applied to other types of apparatuses and many alternatives, modifications, and variations will be apparent to those skilled in the art.

We claim:

1. Method for detecting oscillation in a repeater system comprising:
embedding a wireless communication device circuit in the repeater; and
using the wireless communication device circuit to determine if the repeater system is in oscillation.

2. The method of claim 1, wherein using the wireless communication device circuit comprises:
establishing a call from the wireless communication device circuit to a base station; and
determining oscillation if the call cannot be established.

3. The method of claim 1, wherein using the wireless communication device circuit comprises:
using the wireless communication device circuit to measure signal quality from the base station; and
determining oscillation if the signal quality meets a certain criteria.

4. The method of claim 3, wherein determining oscillation comprises determining oscillation if the signal quality degrades below a certain level.

5. The method of claim 3, wherein determining oscillation comprises determining oscillation if the signal quality degrades from a level that existed before the repeater was used.

6. The method of claim 3, wherein using the wireless communication device circuit comprises:
obtaining signal to noise ratio value to measure the signal quality.

7. The method of claim 1, wherein using the wireless communication device circuit comprises:
using the wireless communication device circuit to estimate at least one open loop power control parameter;
establishing a communication link from the wireless communication device circuit to a base station using the estimated open loop power control parameter;
receiving at least one closed loop power control command from the base station; and
determining oscillation if the closed loop power control command is greater than a certain amount.

8. The method of claim 7, wherein using the wireless communication device circuit comprises estimating at least a required transmit power to complete the call, wherein receiving closed loop power control commands comprises receiving at least power adjustment information, and wherein determining oscillation comprises determining oscillation if the power adjustment information is greater than a certain amount.

9. The method of claim 1, further comprising:
reducing gain of repeater if the repeater system is in oscillation.

10. Apparatus for detecting oscillation in a repeater system comprising:
a wireless communication device circuit embedded in the repeater; and
means for using the wireless communication device circuit to determine if the repeater system is in oscillation.

11. The apparatus of claim 10, wherein means for using the wireless communication device circuit comprises:
means for establishing a call from the wireless communication device circuit to a base station; and
means for determining oscillation if the call cannot be established.

12. The apparatus of claim 10, wherein means for using the wireless communication device circuit comprises:
means for using the wireless communication device circuit to measure signal quality from the base station; and
means for determining oscillation if the signal quality meets a certain criteria.

13. The apparatus of claim 12, wherein means for determining oscillation comprises determining oscillation if the signal quality degrades below a certain level.

14. The apparatus of claim 12, wherein means for determining oscillation comprises determining oscillation if the signal quality degrades from a level that existed before the repeater was used.

15. The apparatus of claim 12, wherein means for using the wireless communication device circuit comprises:
means for obtaining signal to noise ratio value to measure the signal quality.

16. The apparatus of claim 10, wherein means for using the wireless communication device circuit comprises:
means for using the wireless communication device circuit to estimate at least one open loop power control parameter;
means for establishing a communication link from the wireless communication device circuit to a base station using the estimated open loop power control parameter;
means for receiving at least one closed loop power control command from the base station; and
means for determining oscillation if the closed loop power control command is greater than a certain amount.

17. The apparatus of claim 16, wherein means for using the wireless communication device circuit comprises estimating at least a required transmit power to complete the call, wherein means for receiving closed loop power control commands comprises means for receiving at least power adjustment information, and wherein means for determining oscillation comprises determining oscillation if the power adjustment information is greater than a certain amount.

18. The apparatus of claim 10, further comprising:
means for reducing gain of repeater if the repeater system is in oscillation.

19. Apparatus of for detecting oscillation in a repeater system comprising:
a wireless communication device (WCD) configured to detect if the repeater system is in oscillation; and
a processor coupled to the WCD, configured to reduce the gain of the repeater system if the repeater system is in oscillation.
